(19) United States
(12) Patent Application Publication
(10) Pub. No.: US 2016/0132803 A1
(43) Pub. Date: May 12, 2016

(54) INFORMATION PRESENTING METHOD AND INFORMATION PRESENTING DEVICE

(71) Applicant: Fujitsu Limited, Kawasaki-shi (JP)

(72) Inventor: Hiroaki IWASHITA, Tama (JP)

(73) Assignee: Fujitsu Limited, Kawasaki-shi (JP)

(21) Appl. No.: 14/855,611

(22) Filed: Sep. 16, 2015

(30) Foreign Application Priority Data
Nov. 11, 2014 (JP) 2014-228978

(51) Int. Cl. G06Q 10/06; G08B 13/22

(52) U.S. Cl. CPC G06Q 10/06311; G08B 13/22

(57) ABSTRACT

An information presenting method for presenting information that supports a determination of an assignment of security officers within a security zone, the information presenting method includes: acquiring an intrusion position of an intruder and one of a position and range targeted by the intruder on a movement route model that indicates a plurality of routes within the security zone; identifying a line that separates the intrusion position from the one of the target position and the target range on the movement route model, based on a number of routes that the line crosses from among the plurality of routes; and causing a display device to display graph information in which the line is displayed as information indicating the assignment of the security officers on the movement route model.

### CROSS-REFERENCE TO RELATED APPLICATION

This application is based upon and claims the benefit of priority of the prior Japanese Patent Application No. 2014-228978, filed on Nov. 11, 2014, the entire contents of which are incorporated herein by reference.

### FIELD

The embodiments discussed herein are related to a technique for presenting information that supports the determination of the assignment of security officers within a security zone.

### BACKGROUND

For security within a security zone such as a town or a facility, it is important to assign security officers so as to minimize a predicted value of a loss to be caused by the arrival of an intruder at a security target. For security by security officers, it is desirable that a limited number of security officers be efficiently assigned and provide security from the perspective of a labor cost. Thus, the assignment of security officers is determined by referencing support information presented by an information presenting device.

The information presenting device calculates, based on movement routes within a security zone and security requirements, assignment patterns of security officers and probabilities at which the assignment patterns are selected. Then, the information presenting device selects an assignment pattern of the security officers on a movement route based on assignment patterns that are selected at high probabilities and the selection probabilities. Then, the information presenting device outputs a movement route model and the selected assignment pattern as support information to a display device or the like. The security requirements include intrusion positions of an intruder on movement routes, the positions or ranges of security targets, losses upon the arrival of the intruder at the security targets, and the number of the security officers. In addition, upon the outputting of the support information to the display device or the like, the information presenting device uses a certain method or changes a color or the like to highlight positions (sides) to which the security officers are assigned on the movement route model.

The assignment patterns of the security officers and the probabilities at which the assignment patterns are selected are calculated by repeating linear programming and mixed integer programming. For example, related techniques are disclosed in “M. Jain, D. Korzhyk, O. Vanek, V. Conitzer, M. Pechoucek, and M. Tambe. A Double Oracle Algorithm for Zero-Sum Security Games on Graphs. In AAMAS, 2011.” and “M. Jain, V. Conitzer, and M. Tambe. Security Scheduling for Real-world Networks. In AAMAS, 2013.”

### SUMMARY

According to an aspect of the invention, an information presenting method for presenting information that supports a determination of an assignment of security officers within a security zone, the information presenting method includes: acquiring an intrusion position of an intruder and one of a position and range targeted by the intruder on a movement route model that indicates a plurality of routes within the security zone; identifying a line that separates the intrusion position from the one of the target position and the target range on the movement route model, based on a number of routes that the line crosses from among the plurality of routes; and causing a display device to display graph information in which the line is displayed as information indicating the assignment of the security officers on the movement route model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a movement route model;

FIG. 2 is a schematic diagram illustrating a display example of a solution obtained when three security officers are assigned on the model illustrated in FIG. 1;

FIG. 3 is a schematic diagram describing an example of a conventional method of presenting positions to which security officers are assigned on a movement route model;

FIG. 4 is a block diagram illustrating a functional configuration of an information presenting device according to a first embodiment;

FIG. 5 is a flowchart of a method of presenting information according to the first embodiment;

FIG. 6 is a flowchart of a process, included in the method illustrated in FIG. 5, of generating security line candidates;

FIG. 7 is a schematic diagram describing a method of calculating security line candidates that separate a source group from a single partial target group;

FIG. 8 is a schematic diagram describing a method of calculating security line candidates that separate the source group from another single partial target group;

FIG. 9 is a schematic diagram illustrating an example of intermediate results of support information;

FIG. 10 is a flowchart of a process, included in the method illustrated in FIG. 5, of identifying a security line;

FIG. 11 is a schematic diagram illustrating a security region graph generated from the intermediate results, illustrated in FIG. 9, of the support information;

FIG. 12 is a schematic diagram illustrating an example of results of the process of identifying a security line;

FIG. 13 is a schematic diagram illustrating an example of final results of the support information;

FIG. 14 is a schematic diagram illustrating a modified example of a method of presenting the final results of the support information;

FIG. 15 is a block diagram illustrating a hardware configuration of the information presenting device according to the first embodiment;

FIG. 16 is a schematic diagram describing a modified example of the method of presenting information according to the first embodiment;

FIG. 17 is a schematic diagram illustrating intermediate results of the support information that include modified security line candidates;

FIG. 18 is a flowchart of a method of presenting information in which security line candidates are able to be modified;

FIG. 19 is a block diagram illustrating a functional configuration of an information presenting device according to a second embodiment; and

FIG. 20 is a flowchart of a method of presenting information according to the second embodiment.

### DESCRIPTION OF EMBODIMENTS

The support information presented by the aforementioned information presenting device indicates the assignment of security officers that is selected based on assignment patterns of security officers and probabilities at which the assignment patterns are selected. The support information presented by the aforementioned information presenting device, however, does not indicate a reason why the presented assignment is selected. Thus, it takes time and effort for an expert and an operator to evaluate the validity of the presented support information (the assignment of the security officers). Thus, it takes time and effort to determine the assignment of the security officers based on the presented support information.

Techniques disclosed in embodiments simplify evaluation related to information that is presented by a computer and supports the determination of the assignment of security officers.

A reference example of a method of presenting information according to each of the embodiments and the embodiments are described below with reference to the accompanying drawings.

### REFERENCE EXAMPLE

The method of presenting information according to each of the embodiments is a method of generating and presenting information (support information) for supporting the creation of a security plan using an information presenting device such as a computer. Specifically, the determination of the assignment of security officers is supported by calculating and presenting an optimal solution for the assignment of the security officers on a movement route within a security zone.

In the method of presenting information, the movement route within the security zone is expressed by a graph G=(V, E) composed of a group V of vertices (nodes) and a group E of sides (edges). The information presenting device calculates the optimal solution for the assignment of the security officers based on security requirements and a graphed movement route model (hereinafter referred to as “movement route model”). The security requirements include intrusion positions of an intruder, the positions or ranges of security targets, losses upon the arrival of the intruder at the security targets, and the number of the security officers. The positions or ranges of the security targets are positions or ranges targeted by the intruder on the movement route. In addition, the losses upon the arrival of the intruder at the security targets are losses that may be caused by the arrival of the intruder at the positions or ranges targeted by the intruder.

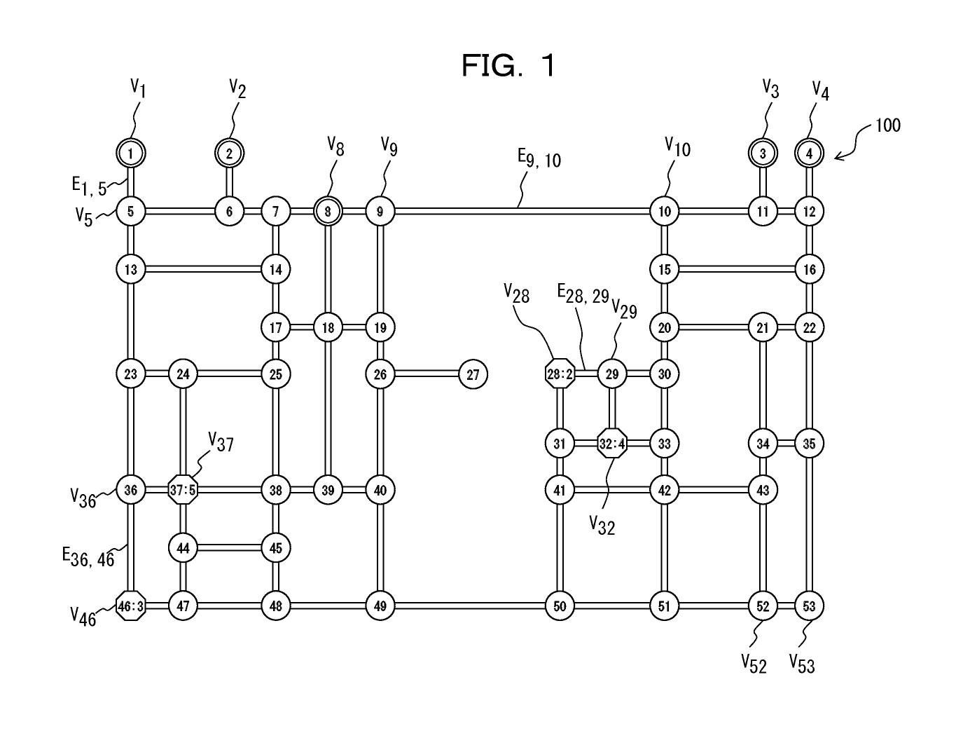

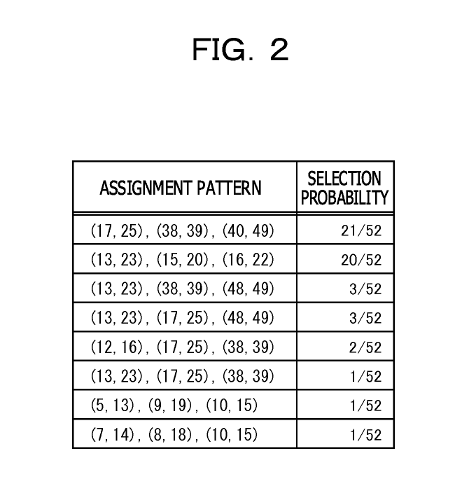

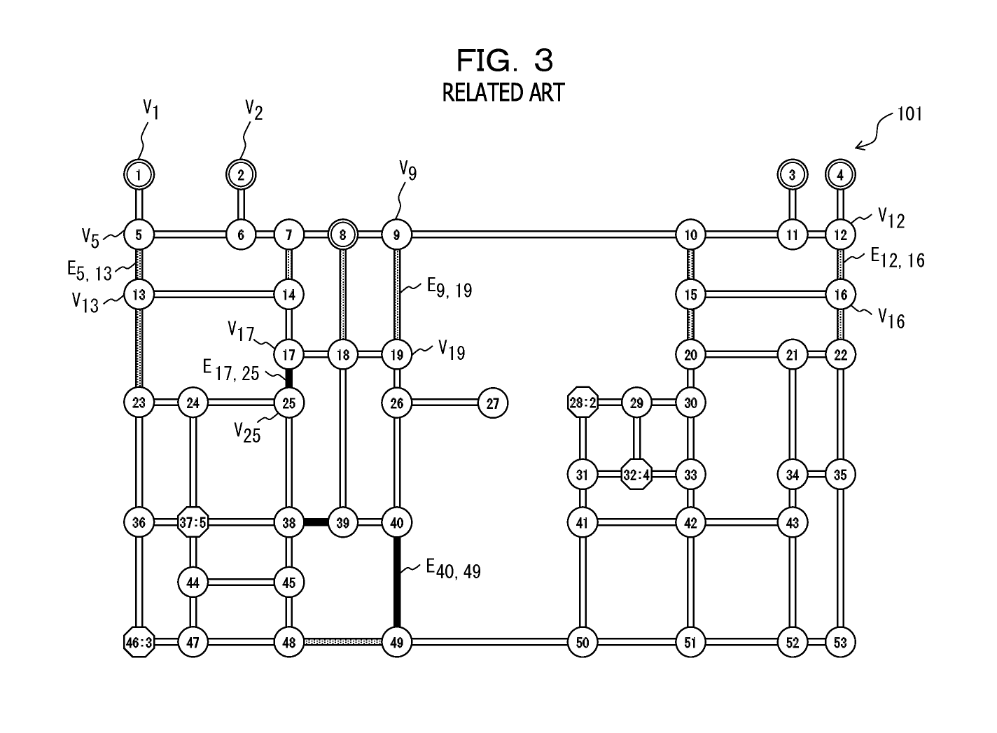

FIG. 1 is a schematic diagram illustrating an example of the movement route model. FIG. 2 is a schematic diagram illustrating a display example of a solution obtained when three security officers are assigned on the model illustrated in FIG. 1. FIG. 3 is a schematic diagram describing an example of a conventional method of presenting positions to which security officers are assigned on a movement route model.

The information presenting device generates or acquires a graph G indicating movement routes. When receiving the security requirements, the information presenting device causes a display device to display a movement route model 100 illustrated in FIG. 1, for example. In the movement route model 100 illustrated in FIG. 1, circles, double circles, and octagons that each have a number i at a central part thereof are vertices Vᵢ, and double lines that are each connected to two vertices Vᵢ and Vⱼ are sides E_{i,j}. In addition, vertices Vᵢ (i=1, 2, 3, 4, 8) indicated by the double circles are vertices set at intrusion positions, while vertices Vᵢ (i=28, 32, 37, 46) indicated by the octagons are vertices set at the positions of security targets. In addition, the vertices Vᵢ (i=28, 32, 37, 46) set at the positions of the security targets each have a sequential number i for the vertex and a number indicating a loss upon the arrival of an intruder.

In FIG. 1, the vertices set at the intrusion positions and indicated by the double circles, and the vertices set at the positions of the security targets and indicated by the octagons, are displayed and distinguished from the other vertices, but are not limited to them. The vertices set at the intrusion positions and the vertices set at the positions of the security targets may be distinguished by colors.

Next, the information presenting device uses the movement route model 100 illustrated in FIG. 1 and the number of security officers to calculate the efficient assignment of security officers. A conventional information presenting device repeats linear programming and mixed integer programming and calculates conceivable assignment patterns of security officers and probabilities at which the assignment patterns are selected. If the number of security officers to be assigned is 3 (k=3), assignment patterns indicating sides to which the security officers are assigned and probabilities at which the assignment patterns are selected are obtained, as illustrated in FIG. 2, for example. The assignment patterns illustrated in FIG. 2 indicate only numbers identifying the sides or indicate numbers (i, j) identifying pairs of vertices Vᵢ and Vⱼ connected to each other.

After that, the support information presenting device identifies, based on the calculated assignment patterns and the calculated probabilities, three sides to which the security officers are assigned, and outputs the movement route model 100 and support information including information of the identified three sides. In order to cause a display device to display the support information, the conventional support information presenting device outputs, to the display device, image data of a movement route model 101 on which the identified sides to which the security officers are assigned are highlighted, as illustrated in FIG. 3, for example. The highlighted sides are not limited to a combination illustrated in FIG. 3 and are arbitrarily selected from multiple combinations in accordance with the assignment patterns illustrated in FIG. 2 and the probabilities illustrated in FIG. 2.

If the identified sides to which the security officers are assigned are highlighted and displayed as illustrated in FIG. 3, positions to which the security officers are assigned are clear, but a reason why the assignment is selected is not clear. In addition, relationships of probabilities at which the highlighted and displayed three sides are selected are not clear even if a display is viewed. Thus, it takes time and effort for an expert and an operator to evaluate the validity of the positions to which the security officers are assigned in the support information (movement route model 101) illustrated in FIG. 3. Thus, it takes time and effort to determine the assignment of the security officers based on the support information, confirm whether or not a security plan is appropriate, and modify the security plan.

On the other hand, in the method of presenting information according to each of the embodiments, a line that divides the movement route model 100 (graph G) is used as described below, positions to which security officers are assigned, and a reason why the assignment of the security officers is selected, are easily understood by using the line, and the positions to which the security officers are assigned are easily evaluated.

### First Embodiment

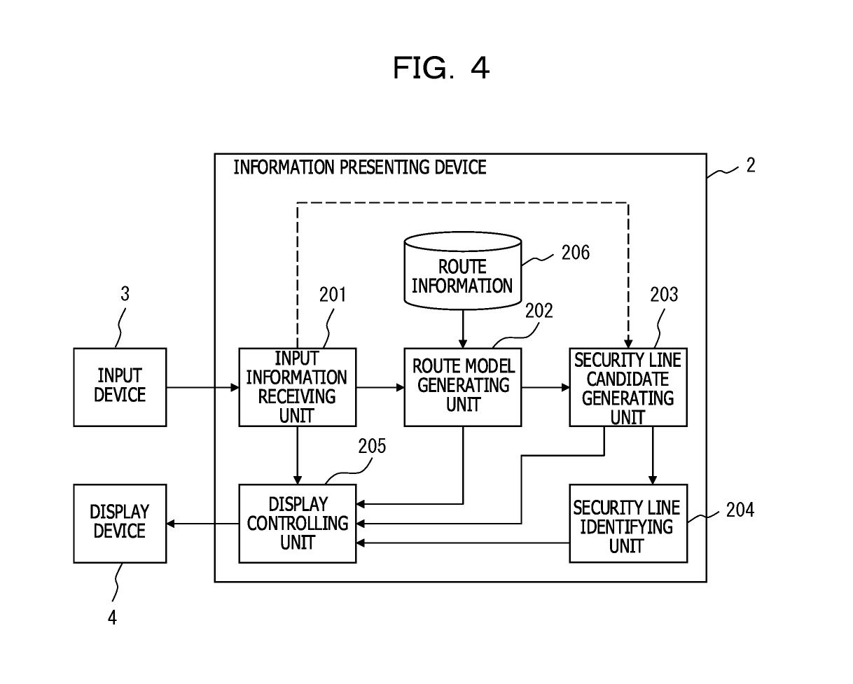

FIG. 4 is a block diagram illustrating a functional configuration of an information presenting device according to the first embodiment.

As illustrated in FIG. 4, the information presenting device 2 according to the first embodiment includes an input information receiving unit 201, a route model generating unit 202, a security line candidate generating unit 203, a security line identifying unit 204, a display controlling unit 205, and route information 206. The information presenting device 2 also includes a storage unit (not illustrated).

The input information receiving unit 201 receives information input through an input device 3 such as a mouse or a keyboard. For example, the received information includes graph information identifying the positions of vertices and connection relationships between the vertices, security requirements, and the like, while the positions of the vertices and the connection relationships are used to generate a movement route model.

The route model generating unit 202 uses the graph information received by the input information receiving unit 201 and the route information 206 to generate the movement route model (graph G). The route model generating unit 202 uses security information received by the input information receiving unit 201 and thereby sets intrusion positions, the positions or ranges of security targets, and the like on the movement route model.

The security line candidate generating unit 203 generates security line candidates based on the movement route model on which the intrusion positions, the positions of the security targets, and the like are set. In addition, the security line candidate generating unit 203 may use the input information received by the input information receiving unit 201 to modify the security line candidates, as described later.

The security line identifying unit 204 uses the security line candidates, losses upon the arrival of an intruder at the security targets, and the number of security officers and thereby identifies an optimal security line from among the security line candidates.

The display controlling unit 205 generates and outputs display data that is to be displayed by a display device 4. The display controlling unit 205 outputs, to the display device 4, the movement route model, intermediate results of support information that include the movement route model and the security line candidates, final results of the support information that include the movement route model and the security line, and the like.

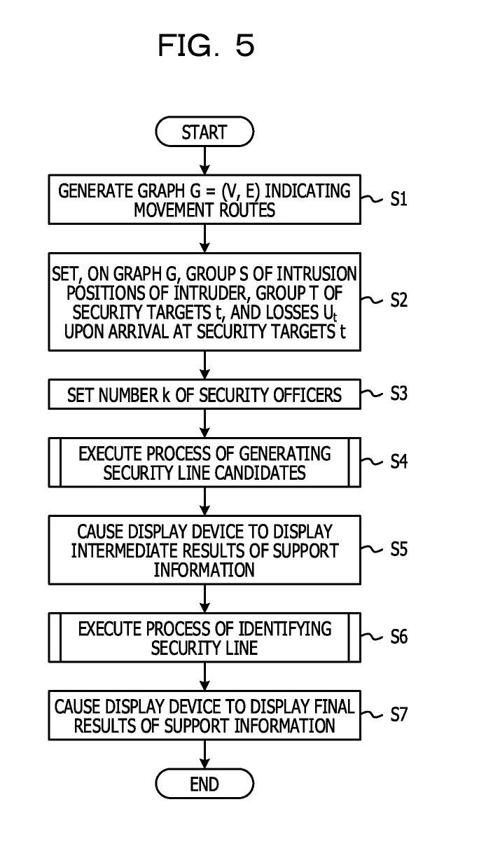

FIG. 5 is a flowchart of a method of presenting information according to the first embodiment.

The information presenting device 2 according to the first embodiment generates a graph G=(V, E) indicating a movement route in order to present the support information related to the assignment of security officers (in step S1), as illustrated in FIG. 5. Step S1 is executed by the movement model generator 202. The movement model generator 202 generates the graph G by any of known graph generation methods. For example, the movement model generator 202 generates the graph G based on the route information 206 and graph information identifying the positions, input by an operator using the input device 3, of vertices on movement routes within a security zone, the number, input by the operator using the input device 3, of the vertices on the movement routes within the security zone, and connection relationships between the vertices. In addition, the route model generating unit 202 causes the display device 4 to display the generated graph G and the graph information of the graph G through the display controlling unit 205, for example.

Next, the information presenting device 2 sets, on the graph G, a group (source group) S of the intrusion positions of the intruder, a group (target group) T of the positions of the security targets, and losses Uₜ upon the arrival of the intruder at the security targets t (in step S2). Step S2 is executed by the route model generating unit 202. The route model generating unit 202 sets the source group S, the target group T, and the losses Uₜ by any of known setting methods that are used by information presenting devices of this type. For example, if the operator uses the input device 3 to input information indicating the start of the setting of the source group S and select vertices on the graph G displayed by the display device 4, the route model generating unit 202 sets the selected vertices as elements of the source group S. In addition, for example, if the operator uses the input device 3 to input information indicating the start of the setting of the target group T, select vertices of the graph G displayed by the display device 4, and input the losses Uₜ, the route model generating unit 202 sets the selected vertices as elements of the target group T. When the source group S, the target group T, and the losses Uₜ are set, the movement route model 100 illustrated in FIG. 1 is displayed by the display device 4 through the display controlling unit 205, for example.

Next, the information presenting device 2 receives an entry of the number k of security officers to be assigned on the movement route model and holds information indicating the number k of security officers (in step S3). Step S3 is executed by the input information receiving unit 201. When receiving information indicating the number k of security officers and input by the operator using the input device 3, the input information receiving unit 201 associates the number k of security officers with the movement route model 100 displayed by the display device 4 and causes the number k of security officers to be stored in the storage unit. The first embodiment assumes that the number of security officers is 3 (k=3) in the same manner as the aforementioned reference example.

After steps S1 to S3, when the operator uses the input device 3 to input information that requests to present security line candidates, the information presenting device 2 executes a process of generating security line candidates (in step S4). The process of generating security line candidates is executed by the security line candidate generating unit 203.

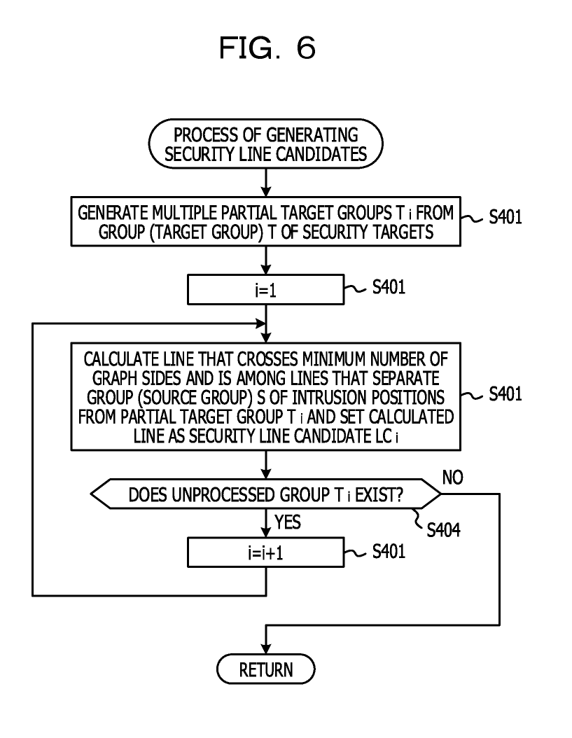

FIG. 6 is a flowchart of the process, illustrated in FIG. 5, of generating security line candidates.

In the process of generating security line candidates, a partial target group Tᵢ that is not composed of multiple empty groups is generated from the group (target group) of the security targets t (in step S401). The partial target group Tᵢ may be generated by combining all elements of the target group T or by combining at least two of all the elements of the target group T. For example, the movement route model 100 illustrated in FIG. 1 includes the target group T={V₂₈, V₃₂, V₃₇, V₄₆}. Thus, when step S4 is executed for the movement route model 100 illustrated in FIG. 1, the partial target group Tᵢ is generated by combining at least one of the four elements V₂₈, V₃₂, V₃₇, and V₄₆.

Next, a variable i that identifies the partial target group Tᵢ is initialized to 1 (in step S402).

Next, a line that is among lines that separate the group (source group) S of the intrusion positions from the partial target group Tᵢ on the movement route model (graph G) and crosses the minimum number of graph sides is calculated and set as a security line candidate LCᵢ (step S403). The line (minimizing line) that crosses the minimum number of the graph sides is calculated using any of methods, known in graph theory, of calculating the minimizing line or is calculated, for example, using a polynomial time algorithm.

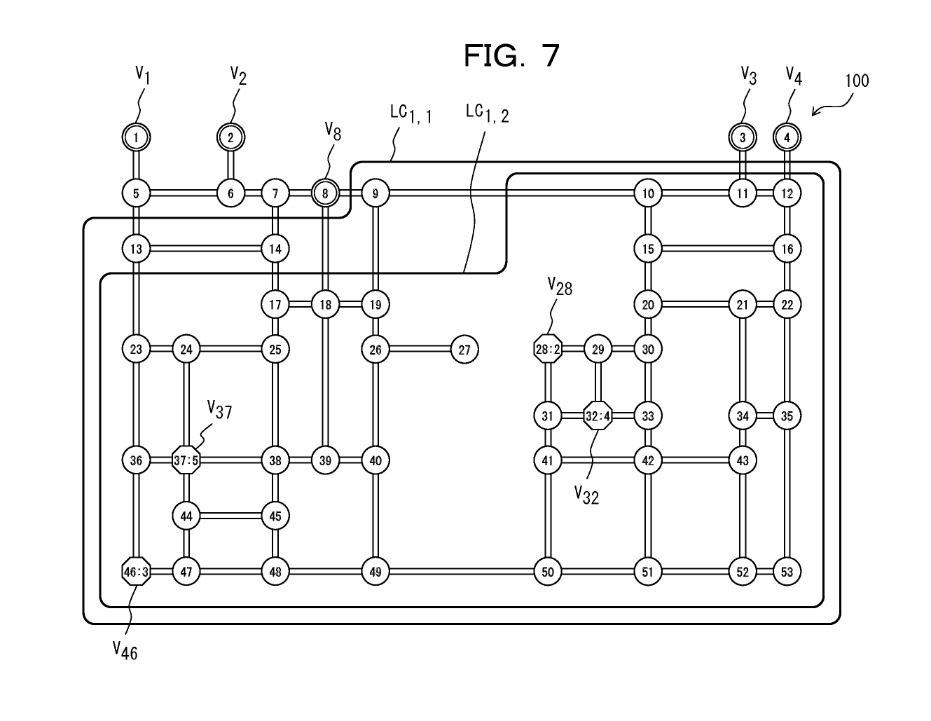

When the partial target group T₁={V₂₈, V₃₂, V₃₇, V₄₆} is generated from the target group T of the movement route model 100 illustrated in FIG. 1, multiple lines that separate the source group S from the partial target group T₁ exist. In FIG. 7, two of the multiple lines that separate the source group S from the partial target group T₁ are illustrated. An outer line LC_{1,1} among the lines illustrated in FIG. 7 crosses six graph sides, while an inner line LC_{1,2} among the lines illustrated in FIG. 7 crosses seven graph sides. When the numbers of graph sides that the other lines that are not illustrated in FIG. 7 cross are calculated, the minimum value among the numbers of graph sides that all the lines that separate the source group S from the partial target group T₁ cross is 6. From among a group of the lines that separate the source group S from the partial target group T₁, a line (for example, the line LC_{1,1} illustrated in FIG. 7) that crosses six graph sides is selected.

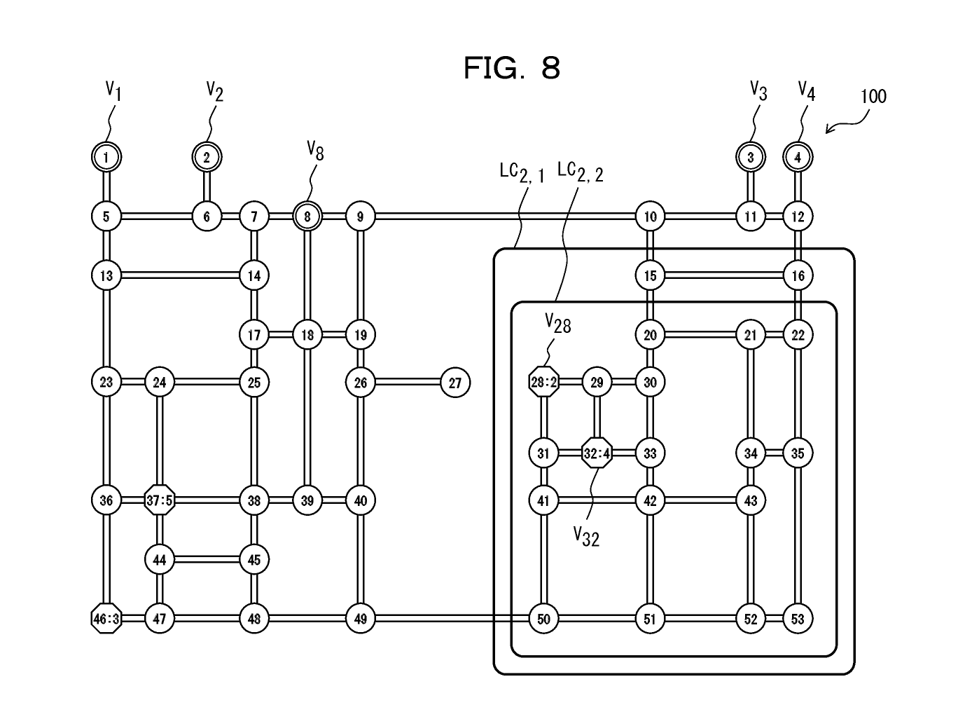

In addition, when a partial target group T₂={V₂₈, V₃₂} is generated from the target group T of the movement route model 100 illustrated in FIG. 1, multiple lines that separate the source group S from the partial target group T₂ exist. In FIG. 8, two of the multiple lines that separate the source group S from the partial target group T₂ are illustrated. The two lines LC_{2,1} and LC_{2,2} illustrated in FIG. 8 each cross three graph sides. When the numbers of graph sides that other lines that are not illustrated in FIG. 7 cross are calculated, the minimum value among the numbers of graph sides that all lines that separate the source group S from the partial target group T₂ cross is 3. From among a group of the lines that separate the source group S from the partial target group T₂, a line that crosses three graph sides is selected as a security line candidate LC₂ that separates the source group S from the partial target group T₂. If multiple lines that each cross the minimum number of graph sides exist as illustrated in FIG. 8, any of the multiple lines that each cross the minimum number of graph sides may be selected as a security line candidate, or all the multiple lines that each cross the minimum number of graph sides may be selected as security line candidates.

When the security line candidate LCᵢ that separates the source group S from a certain one partial target group Tᵢ is calculated in step S403, whether or not an unprocessed partial target group Tᵢ exists is confirmed (in step S404). In step S404, whether or not the partial target group Tᵢ from which a security line candidate LCᵢ is yet to be calculated exists is confirmed.

If the partial target group Tᵢ from which the security line candidate LCᵢ is yet to be calculated exists (Yes in step S404), the variable i is incremented by 1 (in step S405) and step S403 is repeated. On the other hand, if the partial target group Tᵢ from which the security line candidate LCᵢ is yet to be calculated does not exist (No in step S404), the process of generating security line candidates is terminated and returns to the flow illustrated in FIG. 5.

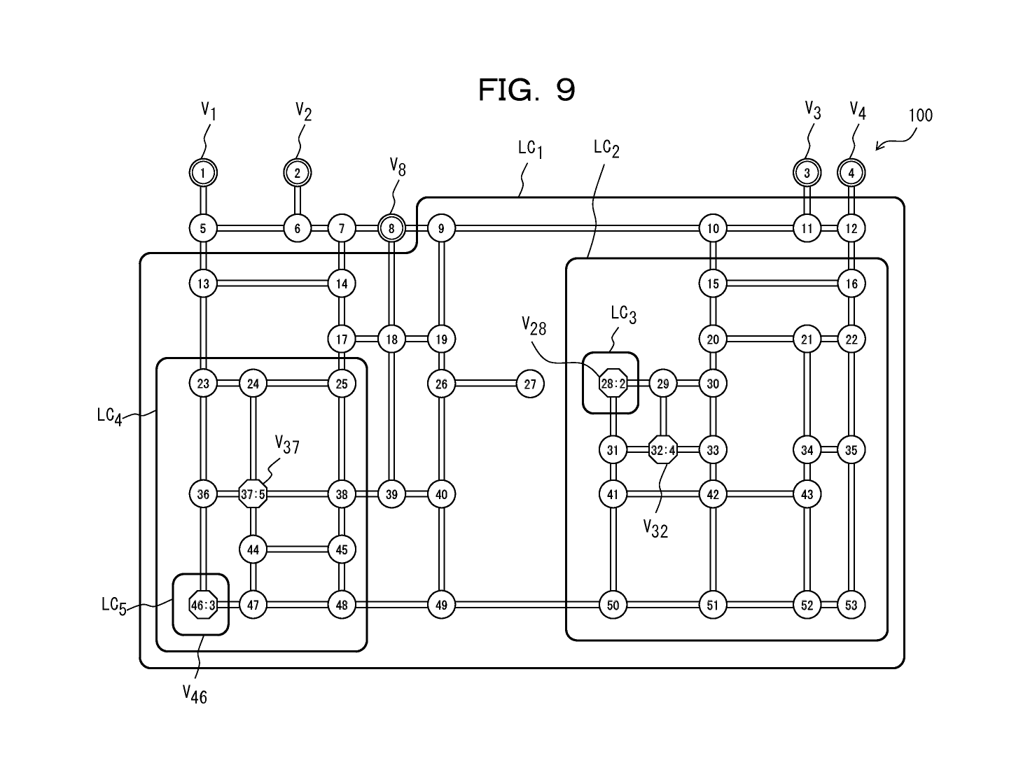

When the process (step S404) of generating security line candidates is terminated, the information presenting device 2 causes the display device 4 to display intermediate results of the support information (in step S5), as illustrated in FIG. 5. The intermediate results of the support information are information including the movement route model and security line candidates. If the partial target group Tᵢ is generated by combining all the elements of the target group T of the movement route model 100 illustrated in FIG. 1, five security line candidates LC₁ to LC₅ are generated as illustrated in FIG. 9. Specifically, the display device 4 displays, as the intermediate results of the support information, an image that includes the movement route model 100 illustrated in FIG. 9 and the security line candidates LC₁ to LC₅.

As is apparent from FIG. 9, a security line candidate LCᵢ crosses a route (graph side) extending from the outside of a region surrounded by the security line candidate LCᵢ toward a target (security target) within the region. The security line candidate LCᵢ is set to ensure that the number of graph sides that the security line candidate LCᵢ crosses is minimal. Thus, the efficient assignment of security officers for a security target (vertex V₃₇) may be easily recognized from the security line candidate LC₄ included in the intermediate results, illustrated in FIG. 9, of the support information. Specifically, when the intermediate results of the support information are displayed by the display device 4, candidates for positions to which the security officers are assigned, and a reason why the candidates are selected, may be easily recognized, and the intermediate results may be easily evaluated.

The intermediate results, illustrated in FIG. 9, of the support information indicate that the total number of graph sides that the security line candidate LC₁ to LC₅ cross is 17. Thus, if the number of security officers that is based on a security plan (security requirements) is 16 or less (k≦16), security officers may not be assigned to all the candidates for the positions. Specifically, if the number of security officers is 17 or greater, security officers may be assigned to all the candidates for the positions. However, if the number of security officers is increased, a labor cost and a security cost increase. In the method of presenting information according to the first embodiment, after steps S4 and S5, a process of identifying a security line is executed (in step S6) in order to present assignment that enables a limited small number of security officers to efficiently provide security. Step S6 is executed by the security line identifying unit 204.

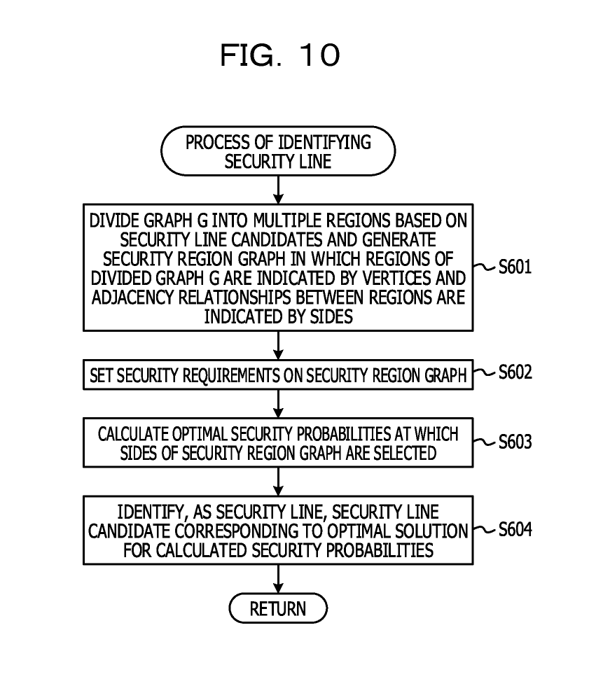

FIG. 10 is a flowchart of the process, illustrated in FIG. 5, of identifying a security line.

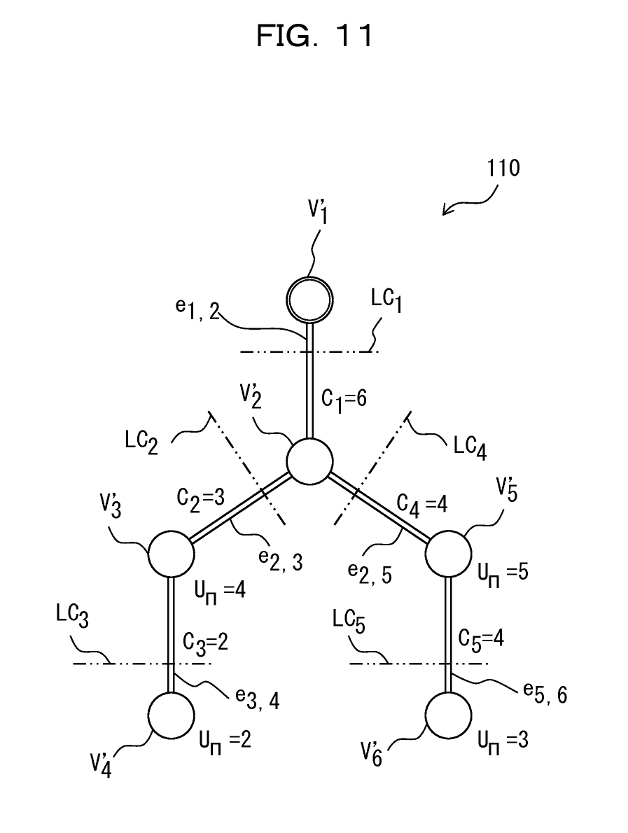

As illustrated in FIG. 10, in the process of identifying a security line, the graph G is divided into multiple regions based on the security line candidates, and a security region graph in which the regions are indicated by vertices and adjacency relationships between the regions are indicated by sides is generated (in step S601). A method of generating the security region graph in step S601 is described using FIG. 11 and the intermediate results, illustrated in FIG. 9, of the support information.

FIG. 11 is a schematic diagram illustrating the security region graph generated from the intermediate results of the support information.

The graph G (movement route model 100) of the intermediate results illustrated in FIG. 9 is divided into the following six regions V′₁ to V′₆ by the five security line candidates LC₁ to LC₅.

The first region V′₁ is a region located on the outer side of a region surrounded by the security line candidate LC₁ or is a region expressed by a group of vertices V₁ to V₈.

The second region V′₂ is a region surrounded by the security line candidate LC₁ and excluding regions surrounded by the security line candidate LC₂ to LC₅ or is a region expressed by a group of vertices V₉ to V₁₄, V₁₇ to V₁₉, V₂₆, V₂₇, V₃₉, V₄₀, and V₄₉.

The third region V′₃ is a region surrounded by the security line candidate LC₂ and excluding a region surrounded by the security line candidate LC₃ or is a region expressed by a group of vertices V₁₅, V₁₆, V₂₀ to V₂₂, V₂₉, V₃₀, V₃₁ to V₃₅, V₄₁ to V₄₃, and V₅₀ to V₅₃.

The fourth region V′₄ is a region surrounded by the security line candidate LC₃ or is a region expressed by only a vertex V₂₈.

The fifth region V′₅ is a region surrounded by the security line candidate LC₄ and excluding a region surrounded by the security line candidate LC₅ or is a region expressed by vertices V₂₃ to V₂₅, V₃₆ to V₃₈, V₄₄, V₄₅, V₄₇, and V₄₈.

The sixth region V′₆ is a region surrounded by the security line candidate LC₅ or is a region expressed by only a vertex V₄₆.

As illustrated in FIG. 11, a security region graph 110 has six vertices V′₁ to V′₆.

First to third adjacency relationships between the aforementioned first to six regions V′₁ to V′₆ on the graph G (movement route model 100) illustrated in FIG. 9 are as follows.

In the first relationship, the second region V′₂ is adjacent to the first region V′₁, the third region V′₃, and the fifth region V′₅.

In the second relationship, the fourth region V′₄ is adjacent to the third region V′₃.

In the third relationship, the sixth region V′₆ is adjacent to the fifth region V′₅.

According to the first relationship, the security region graph 110 includes a side e_{1,2} connecting the vertices V′₁ and V′₂ to each other, a side e_{2,3} connecting the vertices V′₂ and V′₃ to each other, and a side e_{2,5} connecting the vertices V′₂ and V′₅ to each other, as illustrated in FIG. 11. In addition, the security region graph 110 includes a side e_{3,4} connecting the vertices V′₃ and V′₄ to each other and a side e_{5,6} connecting the vertices V′₅ and V′₆ to each other.

After the security region graph is generated from the intermediate results of the support information, security requirements are set on the security region graph based on the intermediate results of the support information (in step S602), as illustrated in FIG. 10. A method of setting the security requirements in step S602 is described below using FIG. 11 and the intermediate results, illustrated in FIG. 9, of the support information.

The security requirements set on the security region graph 110 include an intrusion position (source) of an intruder, the positions (targets) of security targets, routes π extending from the intrusion position to the security targets, losses U_{π} upon the arrival of the intruder at the security targets connected to the intrusion position through the routes π, weights Cₑ of the sides e, and the number k (3 in the first embodiment) of security officers.

It is assumed that the intrusion position of the security region graph 110 is a vertex corresponding to a region including the intrusion position included in the intermediate results (movement route model 100) of the support information. Specifically, it is assumed that the intrusion position of the security region graph 110 is the vertex V′₁.

It is assumed that the security targets included in the security region graph 110 are vertices corresponding to regions including the security targets included in the intermediate results (movement route model 100) of the support information. Specifically, it is assumed that the security targets included in the security region graph 110 are the vertices V′₃ to V′₆.

In addition, it is assumed that the routes that extend from the intrusion position to the security targets are the routes π. Specifically, the routes π included in the security region graph 110 extend from the vertex V′₁ to the vertices V′₃ to V′₆. For example, the route π that is directed from the vertex V′₁ to the vertex V′₄ extends from the vertex V′₁ through the vertices V′₂ and V′₃ to the vertex V′₄. In addition, for example, the shortest route π that is directed from the vertex V′₁ to the vertex V′₅ extends from the vertex V′₁ through the vertex V′₂ to the vertex V′₅.

It is assumed that the losses U_{π} upon the arrival of the intruder at the security targets connected to the intrusion position through the routes π are losses Uₜ upon the arrival of the intruder at the security targets corresponding to the security targets of the security region graph and located in the region of the movement route model 100. For example, the vertex V′₃ of the security region graph 110 corresponds to the third region V′₃ of the movement route model 100 or corresponds to the region surrounded by the security line candidate LC₂ and excluding the region surrounded by the security line candidate LC₃. In the third region V′₃ of the movement route model 100, a security target (vertex V₃₂) for which the loss Uₜ is set to 4 exists, as illustrated in FIG. 9. Thus, the loss U_{π} upon the arrival of the intruder at the vertex V′₃ of the security region graph 110 is set to 4. It is assumed that if multiple security targets exist in a region included in the movement route model 100 and corresponding to a single vertex of the security region graph 110, the sum of losses Uₜ upon the arrival of the intruder at the security targets or the maximum value among the losses Uₜ upon the arrival of the intruder at the security targets is a loss U_{π} upon the arrival of the intruder at the vertex of the security region graph 110.

The weights Cₑ of the sides e are the numbers of sides that security line candidates corresponding to the sides e cross on the movement route model 100. A side e_{i,j} of the security region graph 110 corresponds to a single security line candidate LC_{i,j} that extends between adjacent two regions V′ᵢ, and V′ⱼ. Specifically, routes that extend between two vertices V′ᵢ, and V′ⱼ connected to each other by the side e_{i,j} on the security region graph 110 actually exist for the number of sides that the security line candidate LC_{i,j} corresponding to the side e_{i,j} crosses. Thus, routes π that extend from the vertex V′₁ to the vertex V′₃ on the security region graph 110 correspond to multiple routes on the movement route model 100. Thus, in order to reflect the actual routes of the movement route model 100 in the routes π that extend from the intrusion position to the security targets on the security region graph 110, the weights Cₑ of the sides e are set as one of the security requirements set on the security region graph 110. In FIG. 11, weights of the sides e_{1,2}, e_{2,3}, e_{3,4}, e_{2,5}, and e_{5,6} are represented by C₁ to C₅.

When the security requirements are set on the security region graph, optimal security probabilities at which sides e of the security region graph are selected are calculated (in step S603), as illustrated in FIG. 10. In step S603, an optimization problem with the security probabilities xₑ at which the sides e are selected is expressed by the following formula (1) and solved and an optimal solution for the security probabilities xₑ is calculated, for example.

$$\begin{matrix}minimize & {max}_{π} ( 1 - {\sum }_{θ ∈ π} {x}_{e} ) {U}_{π} \\ subject to & 0 \leq {x}_{e} \leq 1 ∀ e ∈ {E}^{′} \\ & {\sum }_{θ ∈ {E}^{′}} {C}_{e} {x}_{e} = k\end{matrix} \} \qquad ( 1 )$$

In Formula (1), E′ represents a group of the sides e of the security region graph 110. In addition, in Formula (1), π and U_{π} represent the routes extending from the intrusion position to the security targets on the security region graph 110 and the losses upon the arrival of the intruder at the security targets, as described above. In addition, in Formula (1), Cₑ represents the weights of the sides e of the security region graph 110, as described above. Furthermore, in Formula (1), k represents the number of security officers.

By solving Formula (1), a number Cₑ of sides of the movement route model 100 that correspond to the sides e of the security region graph 110 are selected at the security probabilities xₑ.

Formula (1) is an example of a formula for solving the optimization problem with the security probabilities xₑ. The formula for solving the optimization problem with the security probabilities xₑ is not limited to the aforementioned Formula (1), and any of other known formulae may be used. In addition, the formula for solving the optimization problem with the security probabilities xₑ may be a formula obtained by changing a part of a known formula.

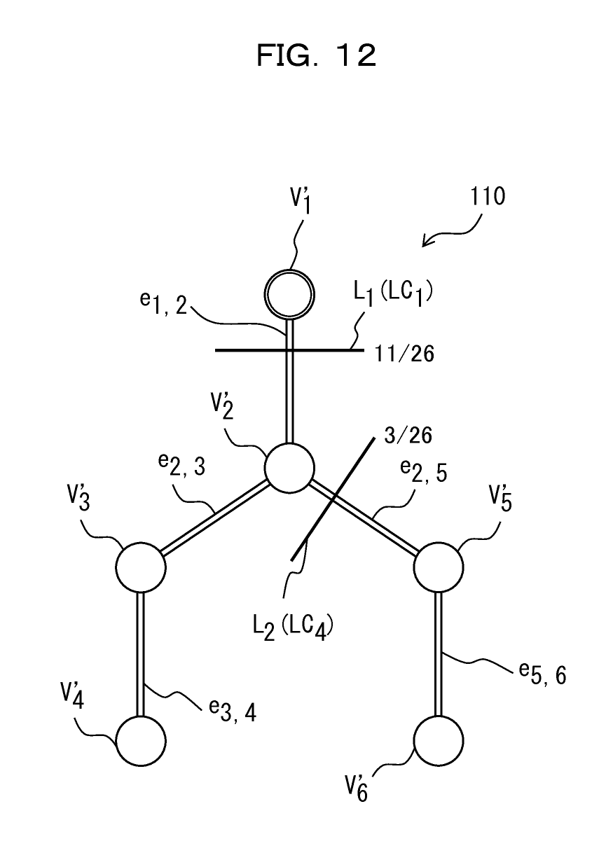

After the optimal security probabilities are calculated in step S603, a security line candidate corresponding to the calculated optimal solution for the security probabilities is identified as a security line (in step S604). A method of identifying the security line in step S604 is described below with reference to FIGS. 11 and 12.

FIG. 12 is a schematic diagram illustrating an example of results of the process of identifying a security line.

When Formula (1) is solved using the security graph 110 illustrated in FIG. 11 and the security requirements, a security probability xₑ at which the side e_{1,2} is selected and a security probability xₑ at which the side e_{2,5} is selected are calculated to be 11/26 and 3/26 as optimal solutions, respectively, for example. The side e_{1,2} is a side connecting the vertices V′₁ and V′₂ to each other and corresponds to the security line candidate LC₁ as illustrated in FIG. 11. In addition, the side e_{2,5} is a side connecting the vertices V′₂ and V′₅ to each other and corresponds to the security line candidate LC₄ as illustrated in FIG. 11. Thus, in step S604, the security line candidates LC₁ and LC₄ that are among the security line candidates LC₁ to LC₅ are identified as security lines L₁ and L₂, as illustrated in FIG. 12. In this case, the security probabilities xₑ calculated in step S603 are associated with the security lines L₁ and L₂, respectively.

When step S604 is terminated, the process of identifying a security line is terminated and returns to the flow illustrated in FIG. 5.

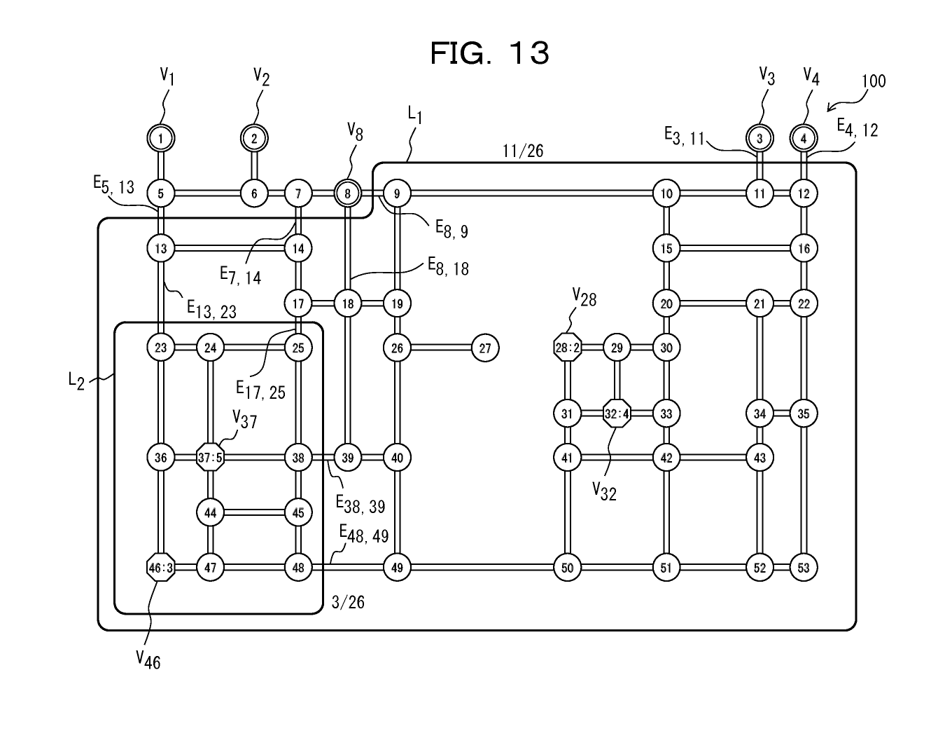

When the process (step S6) of identifying a security line is terminated, the information presenting device 2 causes the display device 4 to display final results of the support information (in step S7), as illustrated in FIG. 5. Step S7 is executed by the display controlling unit 205. The final results of the support information are information including the movement route model and the security lines. When the process of step S6 is executed based on the movement route model 100 illustrated in FIG. 9 and the security line candidates LC₁ to LC₅, the security line candidates LC₁ and LC₄ are identified as the security lines L₁ and L₂, as described above. Thus, in step S7, the display device 4 displays an image that includes the movement route model 100 illustrated in FIG. 13 and the security lines L₁ and L₂ as the final results of the support information. In this case, the optimal security probabilities (11/26 and 3/26) calculated in step S603 are displayed in the vicinity of the security lines L₁ and L₂, for example.

As is apparent from FIG. 13, a security line Lᵢ crosses a route (graph side) that extends from the outside of a region surrounded by the security line Lᵢ to a target (security target) within the region. The security line Lᵢ is a line selected from a security line candidate LCᵢ set to ensure that the number of graph sides that the security line candidate LCᵢ crosses is minimal. Thus, the efficient assignment of security officers for security targets (vertices V₃₇ and V₄₆) may be easily recognized from the security line candidate LC₂ included in the final results, illustrated in FIG. 13, of the support information. In addition, when a security line is identified by solving the aforementioned Formula (1), a number Cₑ of sides that a single security line candidate LCᵢ crosses on the movement route model 100 are selected at the same security probability xₑ. Thus, each of four sides that the security line L₂ crosses on the movement route model 100 is selected at the security probability xₑ=3/26. Specifically, when the movement route model 100 and the security lines Lᵢ are displayed as the final results of the support information, candidates for positions to which security officers are assigned and a reason why the candidates are selected may be easily recognized and the final results may be easily evaluated.

By displaying the optimal security probabilities (for example, 11/26 and 3/26) in the vicinity of the security lines Lᵢ, the efficient assignment of three security officers to ten sides that the security lines Lᵢ illustrated in FIG. 13 cross on the movement route model 100 is easily considered.

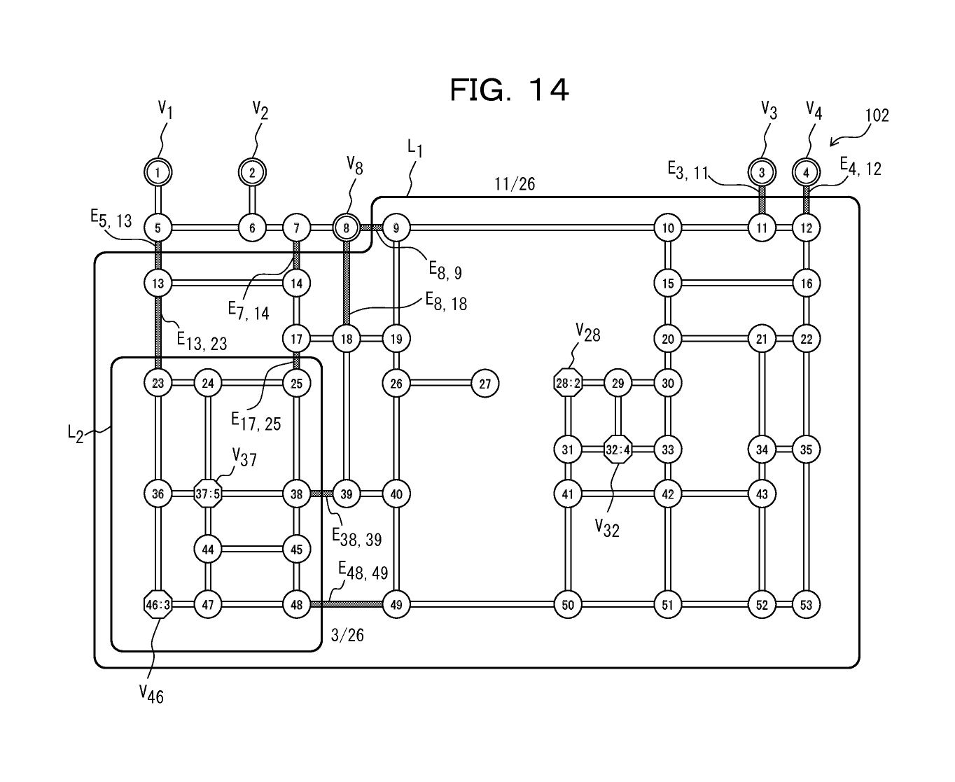

FIG. 14 is a schematic diagram illustrating a modified example of a method of presenting the final results of the support information.

As one of methods of displaying and presenting the final results of the support information by the display device 4, a method of displaying the movement route model 100 and the security lines Lᵢ while overlapping the movement route model 100 and the security lines Lᵢ is indicated in FIG. 13. The method of presenting the final results of the support information, however, is not limited to this. For example, as illustrated in FIG. 14, the sides that the security lines Lᵢ cross among sides of the movement route model 100 may be indicated by another color and presented. In addition, although not illustrated, the sides that the security lines Li cross among the sides of the movement route model 100 may be highlighted by adding marks or the like to the sides and presented.

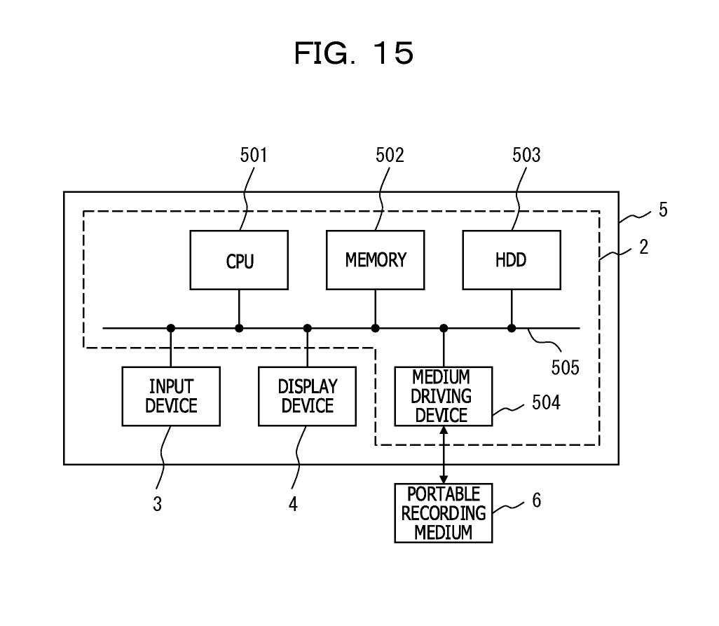

The information presenting device 2 that executes the aforementioned method of presenting information is achieved by a computer and a program that causes the computer to execute the aforementioned method of presenting the support information. A hardware configuration of the information presenting device 2 achieved by the computer and the program is briefly described with reference to FIG. 15.

FIG. 15 is a block diagram illustrating the hardware configuration of the information presenting device according to the first embodiment.

As illustrated in FIG. 15, the computer 5 includes a central processing unit (CPU) 501, a memory 502, a hard disk drive (HDD) 503, a medium driving device 504, the input device 3, and the display device 4. Data may be transmitted between arbitrary two of the CPU 501, the memory 502, the HDD 503, the medium driving device 504, the input device 3, and the display device 4 through a bus 505.

The CPU 501 is an arithmetic processing device configured to execute various programs and thereby control operations of the overall computer 5.

The memory 502 is a semiconductor memory such as a read only memory (ROM) or a random access memory (RAM). A predetermined basic control program to be read by the CPU 501 upon the activation of the computer 5 and the like are stored in the ROM in advance, for example. The RAM is used as a work storage region upon the execution of various control programs by the CPU 501.

The HDD 503 is an auxiliary storage device configured to store the various control programs to be executed by the CPU 501 and data of various types. The CPU 501 reads the programs stored in the HDD 503, executes the programs, and thereby executes the process of presenting the aforementioned support information.

The medium driving device 504 is configured to read various control programs stored in a portable recording medium 6 and data stored in the portable recording medium 6. The CPU 501 may read a predetermined control program stored in the portable recording medium 6 through the medium driving device 504, execute the read predetermined control program, and execute the process of presenting the aforementioned support information. The portable recording medium 6 is a compact disc read only memory (CD-ROM), a digital versatile disc read only memory (DVD-ROM), a storage device provided with a Universal Serial Bus (USB) standard connector, or the like.

The input device 3 is, for example, a keyboard device or a mouse device. When the input device 3 is operated by an operator (user) of the computer 5, the input device 3 transmits input information associated with the operation to the CPU 501.

The display device 4 is, for example, a liquid crystal display and displays various texts and an image that include intermediate results and final results of the support information based on display data transmitted by the CPU 501.

The computer 5 causes the CPU 501, the memory 502, the HDD 503, and the medium driving device 504 to collaborate with each other and execute the aforementioned process in accordance with the flowchart and thereby achieves the functions of the information presenting device 2 illustrated in FIG. 4.

As described above, according to the information presentation method according to the first embodiment and the information presenting device according to the first embodiment, a security line that separates an intrusion position set on a movement route model from a security target (position or range targeted by an intruder) set on the movement route model is identified, and support information that includes the movement route model and the security line is displayed by the display device. Specifically, the security line displayed as the support information crosses a route extending from the intrusion position to the security target. Thus, if security officers are assigned to sides that the security line crosses on the movement route model, the fact that the intruder moving from the intrusion position toward the security target may be caught may be easily recognized from the support information. Thus, the assignment of security officers on a movement route within a security zone may be easily evaluated.

In addition, in the information presentation method according to the first embodiment and the information presenting device according to the first embodiment, if multiple security targets exist, multiple partial groups of security targets are generated and security line candidates that separate the intrusion position from the partial groups of the security targets are generated. Then, an optimal security line is identified from among the multiple security line candidates based on losses upon the arrival of the intruder at the security targets and the number of security officers to be assigned. In addition, if multiple security line candidates that separate the intrusion position from a single partial group of security targets exist, only a security line candidate that crosses the minimum number of sides of the movement route model is set as a security line candidate. Thus, efficient security by a small number of security officers may be supported.

In addition, a security region graph obtained by simplifying the movement route model is used in order to identify an optimal security line from among multiple security line candidates. In this case, the security line candidates and sides that the security line candidates cross on the movement route model are associated with sides e of the security region graph. Then, optimal security probabilities xₑ at which the sides e of the security region graph are selected are calculated from the security region graph and security requirements, and a security line candidate associated with a side e corresponding to an optimal solution is identified as a security line. Specifically, in the information presentation method according to the first embodiment and the information presenting device according to the first embodiment, the security line is identified by solving an optimization problem with the sides e of the security region graph obtained by simplifying the movement route model. Thus, an amount (calculation cost) to be calculated may be significantly reduced, compared with a case where an optimization problem with an intrusion route on the movement route model is solved and a security line is identified.

In addition, when the support information that includes the movement route model and the security line is displayed by the display device, the evaluation of the assignment of security officers may be simplified by displaying a security probability at which the security line is selected and by highlighting sides that the security line crosses on the movement route model.

In the aforementioned process of presenting information, after the security requirements that includes the number k of security officers are set, the process of generating security line candidates and the process of identifying a security line are executed, as illustrated in FIG. 5. The number k of security officers, however, is information to be used to identify a security line from among security line candidates. Thus, the process of setting the number k of security officers in step S3 may be executed between the process of generating security line candidates and the process of identifying a security line.

In addition, in the aforementioned process of presenting information, the generated security line candidates are displayed by the display device 4 as intermediate results of the support information. The process of presenting information, however, is not limited to this. The display device 4 may display only final results of the support information without displaying the intermediate results of the support information. Specifically, the process of step S5 included in the flowchart illustrated in FIG. 5 may be omitted.

In addition, when security line candidates automatically generated by the information presenting device 2 (computer 5) are displayed as the intermediate results of the support information, the operator may use the input device 3 to modify the security line candidates.

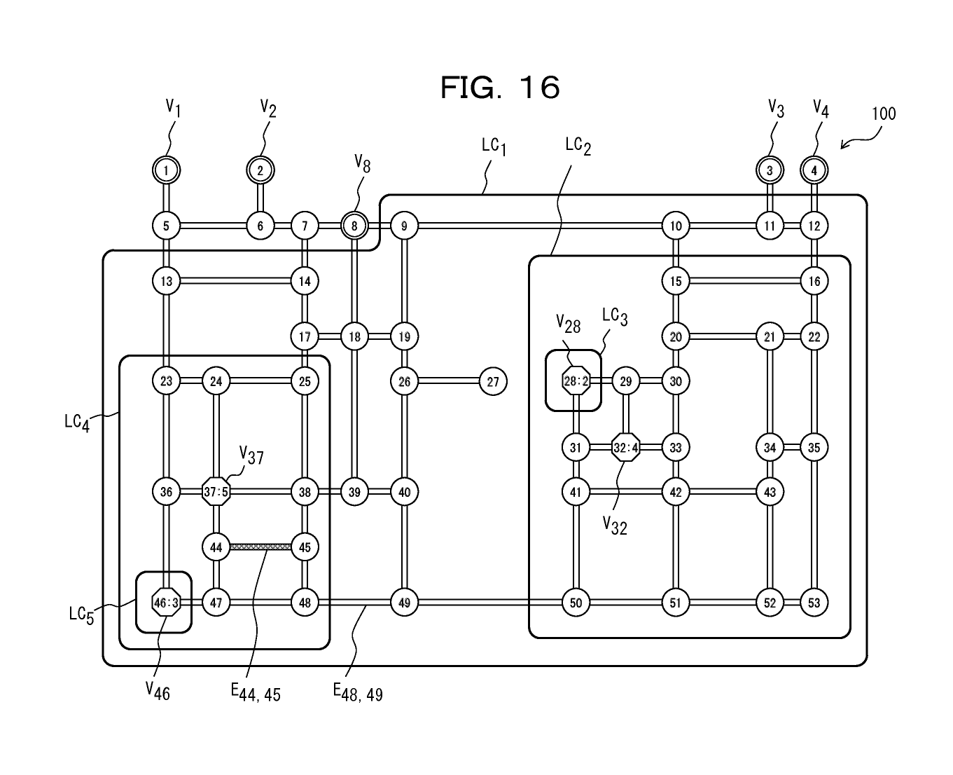

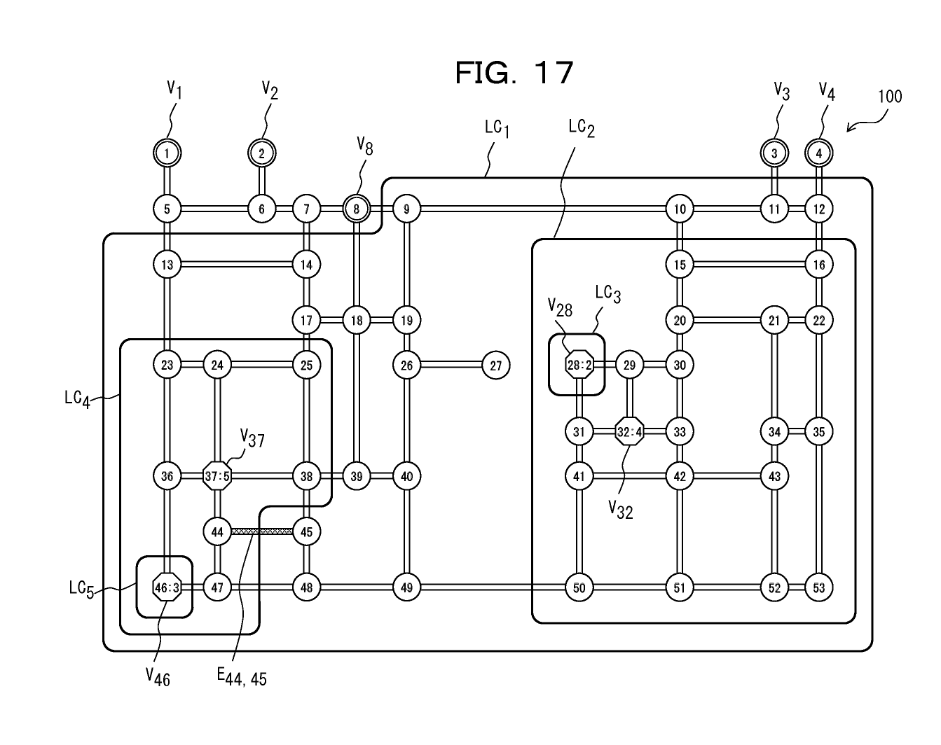

FIG. 16 is a schematic diagram describing a modified example of the process of presenting information according to the first embodiment. FIG. 17 is a schematic diagram illustrating intermediate results of the support information that include modified security line candidates.

Results (intermediate results of the support information) that are obtained by automatically generating security line candidates by the information presenting device 2 in the aforementioned method of presenting information are illustrated in FIG. 16. In the intermediate results, illustrated in FIG. 16, of the support information, the security line candidate LC₄ that surrounds the vertex V₃₇ that is one of security targets crosses sides E_{13,23}, E_{17,25}, E_{38,39}, and E_{48,49} of the movement route model. The security line candidate LC₄ is a line automatically generated as a security line candidate that is among security line candidates separating the source group S from the vertex V₃₇ and crosses the minimum number of sides of the movement route model 100, for example. Specifically, for the generation of the security line candidate LC₄, a location corresponding to the vertex V₃₇ on an actual movement route within the security zone and conditions (the widths of roads, the brightness, the numbers of people, and the like) of regions located near the location are not considered. Thus, a security expert or the like who knows the location corresponding to the vertex V₃₇ and the conditions of the regions located near the location may advise that a security officer be assigned to a side E_{44,45} rather than to a side E_{48,49} in a region located near the vertex V₃₇ as a result of the fact the security expert or the like is asked to evaluate the intermediate results, illustrated in FIG. 16, of the support information. If it is considered to be better to assign a security officer to a side other than sides indicated by the automatically generated security line candidate, it is desirable that the security line candidate LC₄ be modified and an optimal security line be identified, as illustrated in FIG. 17. Thus, it is preferable that the intermediate results of the support information be presented to ensure that the shapes and positions of the security line candidates LC₁ to LC₅ on the movement route model are able to be changed. If the shapes and positions of the security line candidates LC₁ to LC₅ are changed, a security line is identified from among the security line candidates LC₁ to LC₅ after the changes.

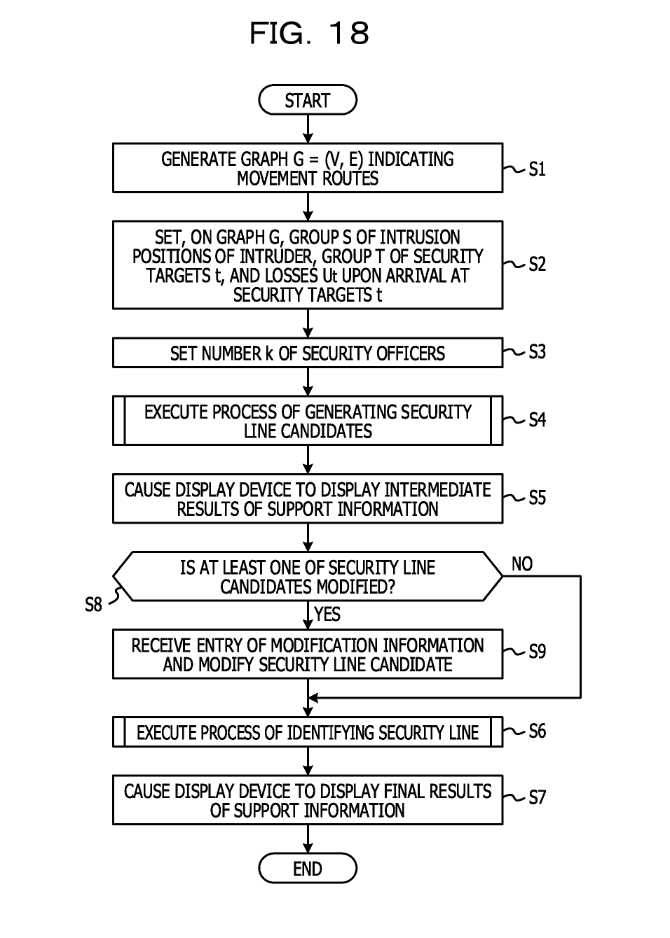

FIG. 18 is a flowchart of a method of presenting information in which security line candidates are able to be changed.

Processes of steps S1 to S5 included in the flowchart illustrated in FIG. 18 are the same as the aforementioned processes of steps S1 to S5 illustrated in FIG. 5. In step S5 of causing the display device to display intermediate results of the support information that include the movement route model and security line candidates, the intermediate results of the support information and a button for selecting whether or not at least one of the security line candidates is modified are displayed by the display device 4.

After step S5, the information presenting device 2 waits for an operator's entry of the result of the selection of whether or not at least one of the security line candidates is modified (in step S8). If information that indicates that the security line candidates are not modified is input (No in step S8), the information presenting device 2 executes the process of identifying a security line using security line candidates generated in step S4 (in step S6). On the other hand, if information that indicates that at least one of the security line candidates is modified is input (Yes in step S8), the information presenting device 2 receives an entry of information on the modification, modifies the security line candidate (in step S9), and executes the process of identifying a security line using the modified security line candidate (in step S6). The security line candidate may be modified using a method of changing the shape and position of the line by drawing software or the like.

Then, the process (step S6) of identifying a security line is terminated, final results of the support information that include the movement route model and the security line are displayed by the display device (in step S7).

Since a part or all of security line candidates automatically generated by the information presenting device 2 (computer 5) is or are modified, the security line candidates may be modified based on conditions, not appearing on the movement route model, of actual movement routes. Thus, a security line that is appropriate for the conditions of the actual movement routes may be identified.

### Second Embodiment

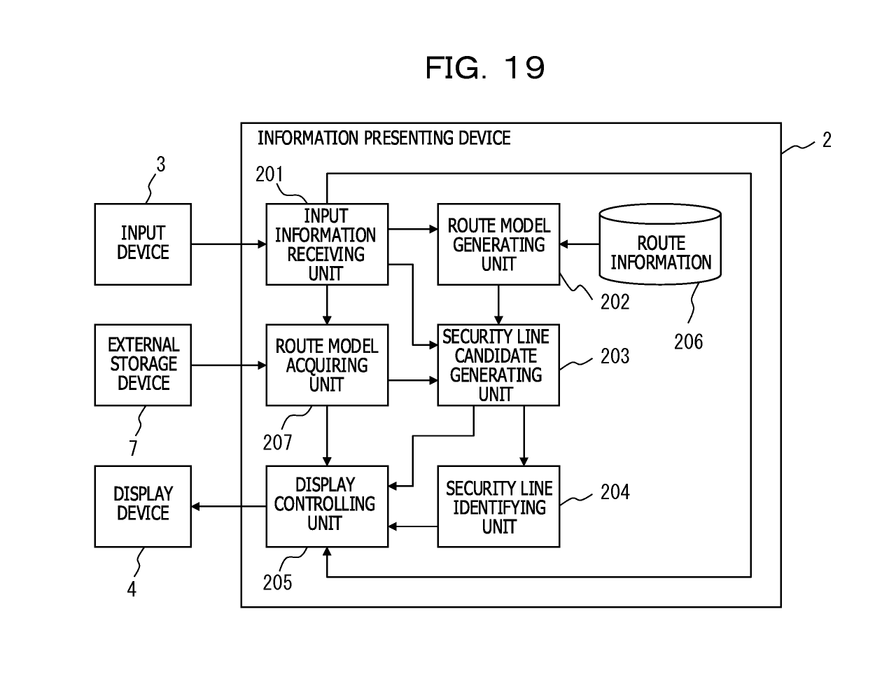

FIG. 19 is a block diagram illustrating a functional configuration of an information presenting device according to a second embodiment.

As illustrated in FIG. 19, the information presenting device 2 according to the second embodiment includes the input information receiving unit 201, the route model generating unit 202, the security line candidate generating unit 203, the security line identifying unit 204, the display controlling unit 205, and the route information 206. In addition, the information presenting device 2 further includes a route model acquiring unit 207.

The input information receiving unit 201 receives information input through the input device 3 such as a mouse or a keyboard. The received information includes graph information identifying the positions of vertices to be used to generate a movement route model, the number of the vertices, and connection relationships between the vertices, security requirements, information to be used to input or modify security line candidates, and the like, for example.

The route model generating unit 202 uses the graph information received by the input information receiving unit 201 and the route information 206 to generate the movement route model (graph G). In addition, the route model generating unit 202 uses security information received by the input information receiving unit 201 to set intrusion positions, the positions or ranges of security targets, and the like on the movement route model.

The security line candidate generating unit 203 generates security line candidates based on the movement route model on which the intrusion positions, the positions of the security targets, and the like are set. In addition, the security line candidate generating unit 203 uses the input information received by the input information receiving unit 201 to modify the security line candidates, and the operatory may manually set security line candidates.

The security line identifying unit 204 uses the security line candidates, the security requirements, and the like to identify an optimal security line from among the security line candidates.

The display controlling unit 205 generates and outputs display data that is to be displayed by the display device 4. The display controlling unit 205 outputs, to the display device 4, the movement route model, intermediate results of the support information that include the movement route model and security line candidates, final results of the support information that include the movement route model and a security line, and the like.

The route model acquiring unit 207 uses the input information received by the input information receiving unit 201 to acquire the movement route model stored in an external storage device 7 or the storage unit (not illustrated) included in the information presenting device 2.

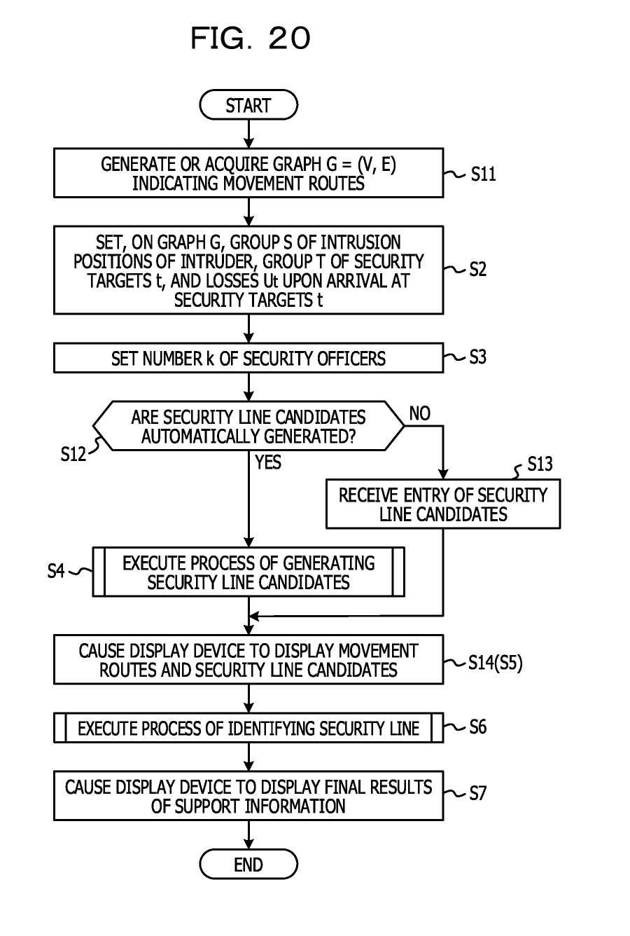

FIG. 20 is a flowchart of a method of presenting information according to the second embodiment.

The information presenting device 2 according to the second embodiment first generates or acquires a graph G=(V, E) indicating movement routes in order to present the support information related to the assignment of security officers (in step S11), as illustrated in FIG. 20. Step S11 is executed by the route model generating unit 202 or the route model acquiring unit 207 based on the input information received by the input information receiving unit 201. If the received input information indicates that a movement route model is to be newly generated, the input information receiving unit 201 causes the route model generating unit 202 to generate the graph G. The route model generating unit 202 generates the graph G by any of known graph generation methods that are used by information presenting devices of this type. For example, the route model generating unit 202 generates the graph G based on the route information 206 and graph information that has been input by the operator using the input device 3 and identifies the positions of vertices on a movement route within a security zone and connection relationships between the vertices. The generated graph G and the graph information input and used for the generation of the graph G are displayed by the display device 4 through the display controlling unit 205, for example.

In addition, if the received input information indicates that the generated graph G is to be selected, the input information receiving unit 201 causes the route model acquiring unit 207 to acquire the graph.

Next, the information presenting device 2 sets, on the graph G, a group (source group) S of intrusion positions of an intruder, a group (target group) T of security targets, and losses Uₜ upon the arrival of the intruder at the security targets (in step S2). Step S2 is executed by the route model generating unit 202 or the route model acquiring unit 207. When generating the graph G, the route model generating unit 202 sets the source group S, the target group T, and the losses Uₜ by any of setting methods that are used by information presenting device of this type. For example, if the operator uses the input device 3 to input information indicating the start of the setting of the source group S and select vertices of the graph G displayed by the display device 4, the route model generating unit 202 sets the selected vertices as elements of the source group S. In addition, for example, if the operator uses the input device 3 to input information indicating the start of setting of the target group T, select vertices of the graph G displayed by the display device 4, and input the losses Uₜ, the route model generating unit 202 sets the selected vertices as elements of the target group T. When acquiring the graph G, the route model acquiring unit 207 sets the source group S, the target group T, and the losses Uₜ by any of the setting methods that are used by information presenting device of this type. When the source group S, the target group T, and the losses Uₜ are set, the movement route model 100 illustrated in FIG. 1 is displayed by the display device 4 through the display controlling unit 205, for example.

Next, the information presenting device 2 receives an entry of the number k of security officers to be assigned in accordance with the movement route model and holds the number k of security officers (in step S3). Step S3 is executed by the input information receiving unit 201. When receiving information indicating the number k of security officers and input by the operator using the input device 3, the input information receiving unit 201 associates the number k of security officers with the movement route model 100 displayed by the display device 4 and causes the number k of security officers to be stored in the storage unit. In addition, although not illustrated in FIG. 20, when receiving the number k of security officers, the information presenting device 2 displays the fact that the information presenting device 2 has received the number k of security officers, and the information presenting device 2 causes the display device 4 to display a button for selecting whether or not security line candidates are automatically generated or the like.

After steps S11, S2, and S3, the information presenting device 2 according to the second embodiment waits for the operator to input the result of the selection of whether or not the security line candidates are automatically generated (in step S12). If information that indicates that the security line candidates are automatically generated is input (Yes in step S8), the process, described in the first embodiment, of generating security line candidates is executed (in step S4). On the other hand, if information that indicates that the security line candidates are not automatically generated is input (No in step S8), an entry of the security line candidates is received (in step S13). The entry of the security line candidates is performed by the operator operating the input device 3 such as a mouse, for example.

When the automatic generation (step S4) of the security line candidates or the reception (step S13) of the entry is terminated, the information presenting device 2 causes the display device to display the movement route model and the security line candidates (in step S14). In step S14, when the security line candidates are automatically generated, intermediate results of the support information are displayed (in step S5 described in the first embodiment).

After step S14, the information presenting device 2 executes the process, described in the first embodiment, of identifying a security line (in step S6) and causes the display device to final results of the support information that include the movement route model and the security line (in step S7).

In this manner, in the method of presenting information according to the second embodiment, the operator may operate the input device 3 to enable the generation of security line candidates. Thus, a security line may be identified from among multiple security line candidates that each cross sides of the movement route model, while the numbers of sides that the security line candidates cross are not minimal. Thus, the method of presenting information according to the second embodiment may flexibly support a case where conditions (for example, the widths of roads, the brightness, the numbers of people, and the like), not appearing on the movement route model, of actual movement routes are to be reflected.

In addition, in the method of presenting information according to the second embodiment, a part or all of automatically generated security line candidates may be modified by an operation performed by the operator, like steps S8 and S9 of the flowchart illustrated in FIG. 18.

In addition, if a generated movement route model is acquired and a security line is identified in the method of presenting information according to the second embodiment, intrusion positions, the positions of security targets, losses upon the arrival of an intruder at the security targets, and the like may be already set on the acquired movement route model. If the movement route model on which the intrusion positions and the like are already set is able to be acquired, the process flow may be changed so as to ensure that the information presenting device 2 determines whether or not the intrusion positions and the like are already set in a step next to step S11 illustrated in FIG. 20, and only if the intrusion positions and the like are not set, the information presenting device 2 executes the process of step S2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information presenting method for presenting information that supports a determination of an assignment of security officers within a security zone, the information presenting method comprising:
acquiring an intrusion position of an intruder and one of a position and range targeted by the intruder on a movement route model that indicates a plurality of routes within the security zone;
identifying a line that separates the intrusion position from the one of the target position and the target range on the movement route model, based on a number of routes that the line crosses from among the plurality of routes; and
causing a display device to display graph information in which the line is displayed as information indicating the assignment of the security officers on the movement route model.

2. The information presenting method according to claim 1,
wherein the line is identified based on security requirements input by a user operating an input device.

3. The information presenting method according to claim 2,
wherein the security requirements include a loss upon arrival at the one of the target position and the target range and the number of the security officers.

4. The information presenting method according to claim 1, further comprising:
generating, when a plurality of target positions is set or a plurality of ranges is set, a plurality of partial groups of the target positions or the target ranges; and
generating, for each of the plurality of partial groups, line candidates that separate the intrusion position from all target positions included in the partial group or all ranges included in the partial group.

5. The information presenting method according to claim 4, further comprising:
identifying, for each of the plurality of partial groups, a single line candidate from among the line candidates based on the number of routes that the line that crosses among the plurality of routes; and
causing the display device to display the single line candidate for each of the plurality of partial groups.

6. The information presenting method according to claim 1, further comprising:
generating a plurality of line candidates that separate the intrusion position from the one of the target position and the target range before the identifying of the line; and
identifying the line from among the plurality of line candidates based on security requirements input by a user operating an input device.

7. The information presenting method according to claim 6, further comprising:
dividing the movement route model into a plurality of regions based on the plurality of line candidates;
generating a security region graph in which the plurality of regions are indicated by vertices and connection relationships between the regions are indicated by sides;
using the security requirements and the security region graph to solve an optimization problem with security probabilities at which the sides of the security region graph are selected; and
identifying the line based on an optimal solution for the security probabilities.

8. The information presenting method according to claim 7, further comprising:
causing the display device to display the movement route model and the plurality of line candidates after the generating of the plurality of line candidates.

9. The information presenting method according to claim 1, further comprising:
displaying routes that the line crosses among the plurality of routes, in a different form from other routes in the graph information.

10. An information presenting device for presenting information that supports a determination of an assignment of security officers within a security zone, the information presenting device comprising:
a memory; and
a processor coupled to the memory and configured to:
acquire an intrusion position of an intruder and one of a position and range targeted by the intruder on a movement route model that indicates a plurality of routes within the security zone,
identify a line that separates the intrusion position from the one of the target position and the target range on the movement route model, based on a number of routes that the line crosses from among the plurality of routes, and
cause a display device to display graph information in which the line is displayed as information indicating the assignment of the security officers on the movement route model.

11. A non-transitory storage medium storing an information presenting program for causing a computer to execute a process, the process comprising:
acquiring an intrusion position of an intruder and one of a position and range targeted by the intruder on a movement route model that indicates a plurality of routes within the security zone;
identifying a line that separates the intrusion position from the one of the target position and the target range on the movement route model, based on a number of routes that the line crosses from among the plurality of routes; and
causing a display device to display graph information in which the line is displayed as information indicating the assignment of the security officers on the movement route model.

12. The non-transitory storage medium according to claim 11,
wherein the line is identified based on security requirements input by a user operating an input device.

13. The non-transitory storage medium according to claim 12,
wherein the security requirements include a loss upon arrival at the one of the target position and the target range and the number of the security officers.

14. The non-transitory storage medium according to claim 11, the process further comprising:
generating, when a plurality of target positions is set or a plurality of ranges is set, a plurality of partial groups of the target positions or the target ranges; and
generating, for each of the plurality of partial groups, line candidates that separate the intrusion position from all target positions included in the partial group or all ranges included in the partial group.

15. The non-transitory storage medium according to claim 14, the process further comprising:
identifying, for each of the plurality of partial groups, a single line candidate from among the line candidates based on the number of routes that the line that crosses among the plurality of routes; and
causing the display device to display the single line candidate for each of the plurality of partial groups.

16. The non-transitory storage medium according to claim 11, the process further comprising:
generating a plurality of line candidates that separate the intrusion position from the one of the target position and the target range before the identifying of the line; and
identifying the line from among the plurality of line candidates based on security requirements input by a user operating an input device.

17. The non-transitory storage medium according to claim 16, the process further comprising:
dividing the movement route model into a plurality of regions based on the plurality of line candidates;
generating a security region graph in which the plurality of regions are indicated by vertices and connection relationships between the regions are indicated by sides;
using the security requirements and the security region graph to solve an optimization problem with security probabilities at which the sides of the security region graph are selected; and
identifying the line based on an optimal solution for the security probabilities.

18. The non-transitory storage medium according to claim 17, the process further comprising:
causing the display device to display the movement route model and the plurality of line candidates after the generating of the plurality of line candidates.

19. The non-transitory storage medium according to claim 11, the process further comprising:
displaying routes that the line crosses among the plurality of routes, in a different form from other routes in the graph information.
